(19) United States
(12) Patent Application Publication
(10) Pub. No.: US 2010/0205539 A1
(43) Pub. Date: Aug. 12, 2010

(54) INSTANT MESSAGING AND TELEPHONY VALUE ADDED SERVICES

(75) Inventors: Arnar Gestsson, Kolding (DK); Birkir Marteinsson, Reykjavik (IS); Erik Figueras Torras, Hafnarfjorour (IS)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: AMIVOX ehf., Reykjavik (IS)

(21) Appl. No.: 12/704,851

(22) Filed: Feb. 12, 2010

Related U.S. Application Data
(60) Provisional application No. 61/152,134, filed on Feb. 12, 2009.
(60) Provisional application No. 61/152,452, filed on Feb. 13, 2009.

(51) Int. Cl. G06F 3/01; G06F 15/16

(52) U.S. Cl. 715/752

(57) ABSTRACT

A method of communication between an instant messaging user and external applications is disclosed. The instant messaging user can communicate multimedia messages with traditional telephony users, with SMS and MMS users, with email users and with IM users of other instant messaging communities. Likewise, the instant messaging user can post and retrieve entries into and from a message board and into and from his blog space directly from the instant message client. Moreover, the instant messaging user can establish chat sessions with other instant messaging users without need to share one another's presence. Furthermore, the instant messaging user can place queries to a call center directly from the instant message client.

### CROSS-REFERENCE TO RELATED APPLICATION

The present application is based on provisional application Ser. No. 61/152,134, filed Feb. 12, 2009. The present application is related to provisional application Ser. No. 61/046,976, filed Apr. 22, 2008, provisional application Ser. No. 61/152,452, filed Feb. 13, 2009, and Ser. No. 12/425,447, filed Apr. 17, 2009. The entire text and drawings of all of the above-referenced applications are incorporated by reference into this application as if fully set forth herein.

### BACKGROUND

In provisional patent application Ser. No. 61/046,976, filed Apr. 22, 2008, the Amivox communication framework is disclosed. The Amivox communication framework is a messaging system where users' unique user names or user IDs are their telephone numbers. Upon registration, a user shall provide his telephone number (which is unique by nature), his email (which is unique by nature) and his alias of preference (which must not be unique).

U.S. Pat. No. 7,272,634 is entitled “system and method for integrating multiple messaging systems. The abstract of this patent states the patent discloses a system and method for allowing a sender to use a generic message entry form for all messaging systems, including email, instant messaging, and the like. The user enters the recipient's name and the message, and a dispatch server intelligently routes the message to the recipient using an appropriate messaging engine. The content of this patent is incorporated by reference into this patent application as if fully set forth herein.

The present invention considers that a messaging system can store relevant data of its users such as the email address, mobile telephone number, data storage address (e.g., their blog space, their user profile in a social environment such as Facebook, etc.), etc. Therefore, in certain instances it is defined that calls can be established automatically to messaging users, SMS/MMS messages can be automatically addressed to messaging users, email messages can be sent to messaging users, and messages can be directed to messaging users' data storage spaces.

Traditional messaging and instant messaging services are not capable to deliver audio messages to traditional telephone users.

Traditional messaging and instant messaging services are not capable to establish audio chat sessions with traditional telephone users.

Traditional messaging and instant messaging services are not capable to deliver multimedia messages (multimedia messages with video and/or picture and/or audio and/or text) to SMS receivers.

Traditional instant messaging services are not capable to deliver multimedia messages to Email receivers.

Traditional messaging and instant messaging services are not capable to deliver multimedia messages to other instant messaging communities.

Some user segments such as young children, senior users or disabled communities may not be capable to understand the presence status information (available, away, busy, offline, etc.) of messaging buddies.

Instant messaging services focus on real time messaging services and access to external services or external communication platforms is, in most cases very limited or not at all possible.

Buddy based instant messaging services do not provide access to messaging boards or blogging spaces

For communications which are intended to be one-off sessions, or which do not intend to build a long term buddy relationship, buddy acceptance and subsequent sharing of presence information is often an unwanted process for the end users.

Running an effective and good quality call centre can proof challenging, with call centers or telephone help desk centers getting saturated at certain peak times, resulting in long waiting times for the callers.

### BRIEF DESCRIPTION OF THE DRAWINGS

FIG. 1A is a flow diagram of an example of an instant messaging session between an instant messaging user and a fixed line telephone user.

FIG. 1B is a table that lists a call sequence that can take place in accordance with an embodiment of the present invention.

FIG. 2 is a flow diagram of an example of a voice chatting between an instant messaging user and a fixed line telephone user.

FIG. 3 is flowchart showing an example of the options that an instant messaging user has when sending micro call messages to telephone users.

FIG. 4 is a flow diagram of an example of alternative means that a user has to deliver an audio message to a telephone user who didn't receive the micro call.

FIG. 5 is a flow diagram of an example of a multimedia messaging session between an instant messaging user and an SMS/MMS user.

FIG. 6 is a flow diagram of an example of a multimedia messaging session between an instant messaging user and an email user.

FIG. 7 is a flow diagram of an example of a multimedia messaging session between an instant messaging user and a user from a different instant messaging community.

FIG. 8 is a flow diagram of an example of an intelligent message routing.

FIG. 9 is a flowchart showing an example of an intelligent message routing criteria.

FIG. 10 is an example of a message board's public, private and restricted spaces.

FIG. 11 is an example of a message board.

FIG. 12 is a flow diagram of an example of an invitation process to a one-off chat FIG. 13 is a flow diagram of an example of queue-free call centre.

### DETAILED DESCRIPTION

Words importing the singular may include the plural and vice versa. Words importing a particular gender may include any gender.

Traditional messaging and instant messaging services are not capable to deliver audio messages to traditional telephone users. With the present invention, messaging and instant messaging users can record an audio message and/or retrieve existing audio content and send it to any fixed phone, mobile phone, or IP telephone user in the world so long they know the telephone number. The present invention also allows the receiver of such an audio message to reply to the message and establish an audio chat session with the sender, or to forward the audio message to a third destination, or to establish, via one click, a live call with the sender of the audio message.

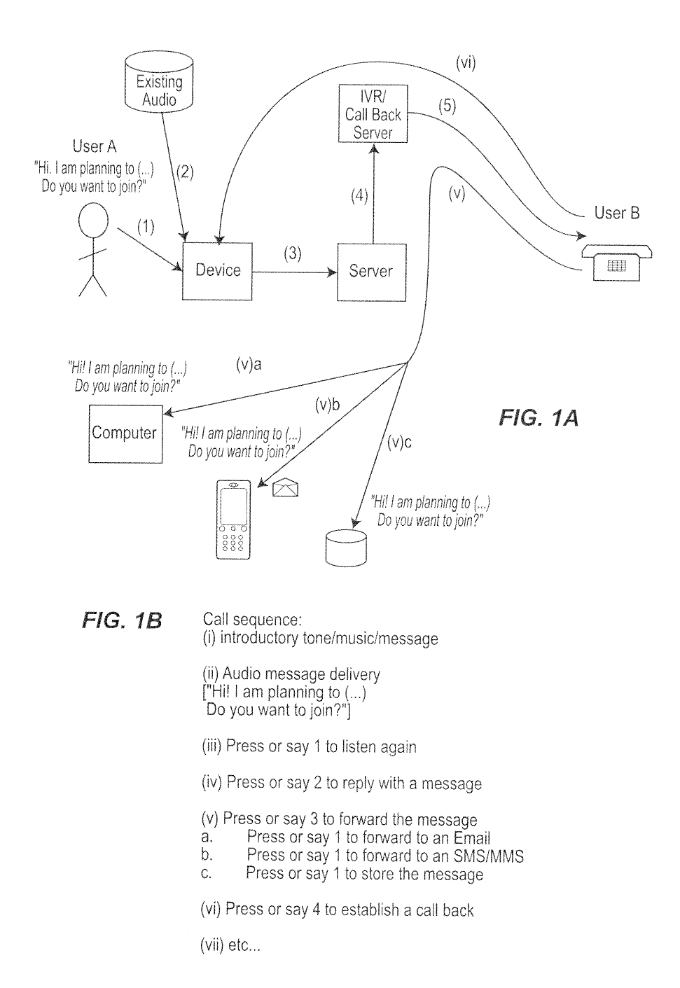

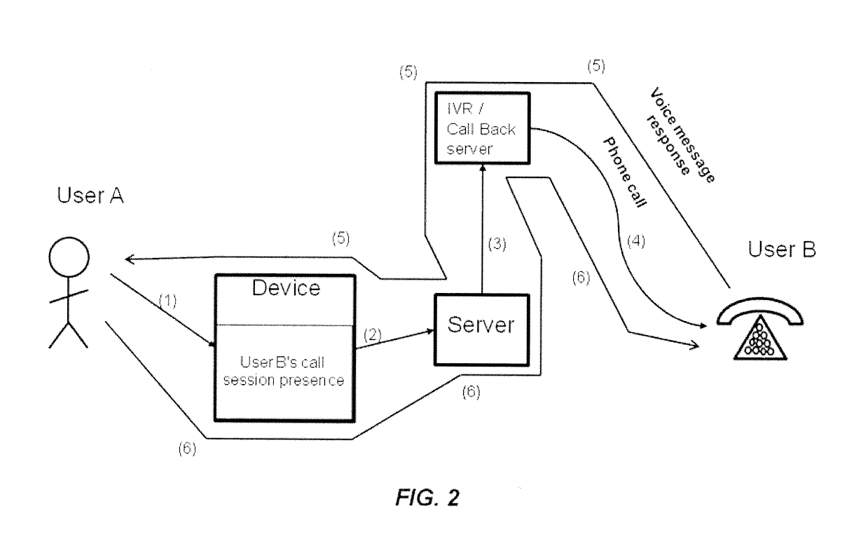

FIG. 1 shows a messaging user (user A) with an electronic device (Device) that delivers over a Server and an IVR/Call Back system an audio message to a remote fixed line user (user B). User B could likewise be using a cordless phone, a mobile phone or a VoIP phone. The server forwards the audio message and user B's telephone number to the IVR system. The IVR system places a call to user B's number, and upon answering the call, user B hears a short introductory audio (tone, advertisement, music or some other signal) that makes the receiver aware of the fact that an audio message is about to be played. Right after hearing the system audio, user B listens to the audio message sent by user A. At the end of the audio message, the IVR system presents user B with a number of options to choose from such as (1) to listen the audio message again, (2) to record an audio message and send it back to user A, (3) to forward the message to a separate destination, (4) to establish a call to the sender of the received audio message, etc.

According to an exemplary aspect of the present invention, the system can be designed in such a form that, for example, the calling line identification is set to match the telephone number of the sending party (user A) using the appropriate protocol (SIP, Signaling System 7, H323, etc.). This way, the receiver of the call can view who is calling him before answering. Upon answering the call, the short introductory audio will immediately announce to user B that it is not a live call but a micro call that is delivering a voice message.

User A can, for example, likewise choose to send an audio message to multiple receivers at once. Receivers can be any mix of telephone users, instant messaging users, email users, SMS users, MMS users, etc. Likewise, user A can do the editing and sending action of the audio message while his client is in offline mode (i.e., disconnected from the server). The audio message will be stored and automatically submitted to the server for delivery to the intended recipient(s) immediately after the client has become online (i.e., connected to the server).

When composing the original audio message, user A has, at least, control over the following options:

Sender's option a: to offer to assume the cost of the call in case user B decides to establish a call back. In this case, after hearing user A's voice message, user B will receive an announcement with the explanation that he can trigger a call back to user A by sending a specific DTMF tone (pressing a specific key) or by saying a specific word (thanks to the IVR's voice recognition engine).

Sender's option b: to remove the option for user B to establish a call back. In this case, after hearing user A's voice message user B will not receive the announcement that he can trigger a call back to user A.

Sender's option c: to allow user B to reply with an audio message. In this case, after hearing user A's voice message, user B will receive the announcement that he can record a voice message to be sent back to use A. After doing so, the voice message from user B will be immediately forwarded to user A via the supported messaging protocol.

Sender's option d: to not allow user B to reply with an audio message. In this case, after hearing user A's voice message user B will not receive the announcement that he can record a voice message to be sent back to use A.

Sender's option e: to select the DTMF response mechanism. In this case, user A needs to define the meaning of certain key presses. For instance, he can assign “1” to the meaning of “Yes”, “2” to the meaning of “No” and “3” to the meaning of “I don't know”. This way, user A can send a voice message like “Hi Eric, are you coming with us to the cinema this evening?” and after hearing user A's voice message, user B will receive an announcement of the form press or say “1” to reply with “Yes”, press or say “2” to reply with “No” and press or say “3” to reply with “I don't know”. If user B presses or says “2”, the response “No” (either in text, audio or graphical form) will be immediately forwarded back to user A via the messaging protocol.

Sender's option f: to not allow user B to forward the received audio message elsewhere.

FIG. 1A is a table that lists an exemplary sequence of an audio message sent by user A from his messaging client to a user B's phone and the options that the receiver has after hearing the message: User A captures audio and/or retrieves stored existing audio content, and addresses it as a micro call (a dialed-out message) to a fixed user B. The messaging software application in user A's electronic device transfers the audio message to the central server, which stores the audio message. The server transfers the audio message and user B's telephone number to the IVR/Call Back server which generates an outcall (micro call) to user B. When the call gets answered, and after an audible introduction, the audio message is played.

At the end of the audio message, user B is presented with a number of IVR options. If user B wants to listen again to the received message, he can choose the appropriate IVR option to hear it again. If user B wants to reply to the message, he can choose the appropriate IVR option to leave a voice message back to user A. The voice message will be recorded within the call session by the IVR system and immediately transferred to the server and forwarded to the messaging client in user A's electronic device.

The software client application in user A's device can notify in real time the presence of user B. If user B does not hang up after replying to the message, user A will hence be notified that user B remains available (“online” in that particular call session) and can resume the messaging loop all over again. This can be done bye, for example, recording and sending another audio message to user B (effectively starting from the beginning, but in this case knowing that user B remains on the telephone awaiting for additional messages). After user A sends the second audio message, user B will receive it instantly (delivered by the IVR system) and he will be able to reply once again with a voice message (step FIG. 1 (iv)).

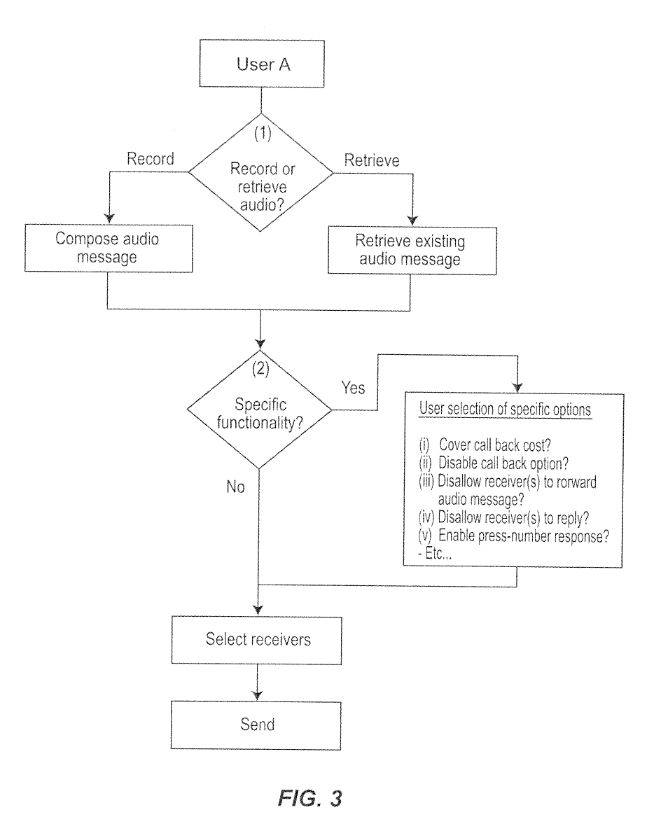

With the above-described mechanism, users A and B effectively establish an instant messaging voice communication between a messaging user (user A) and a fix or mobile or VoIP telephone user (user B). As shown in FIG. 2, the IVR system captures user B's audio message and forwards it to the server (5), which in turn forwards it to user A's instant messaging client for the user to listen to it. From his messaging client, user A can visualize in real time the presence information of user B. This way, user A can tell whether user B is still “online” (in a call session with the IVR system) or whether he has already hung up. This presence information allows user A to know in real time whether his next audio message to user B (6) will be delivered within the same call session or whether a new micro call will be started in order to deliver the audio message to user B.

Referring back to FIG. 1A, if user B wants to forward the received audio message, he has several options:

Forwarding option a: forward the received audio message as an email. In this case, user B will choose the appropriate IVR option to forward the received message to an email account. The email account can, for example, (i) be pre-registered in the server by user B and selected via DTMF or voice recognition IVR traditional functionality, or (ii) be provided by user B via a voice recognition software or sequential key presses (for example, eric@hotmail.com being entered as “33 [pause] 777 [pause] 444 [pause] 222 [pause] # [pause] 44 [pause] 666 [pause] 8 [pause] 6 [pause] 2 [pause] 444 [pause] 555 [pause]* [pause] 222 [pause] 666 [pause] 6”). An email, including some predefined explanatory text (for example, “Hi! I am forwarding you a voice message! You can listen to it by clicking the link below”) and a URL/hyperlink link for the future retrieval of user A's audio message, will be immediately generated and sent to the email account selected by user B.

Forwarding option b: forward the received audio message as an SMS/MMS message. In this case, user B will choose the appropriate IVR option to forward the received message as an SMS/MMS message to any phone user. The SMS/MMS message will include some explanatory text (for example, “Hi! I am forwarding you a voice message! You can listen to it by clicking the link below”) and a URL/hyperlink link for the future retrieval of user A's audio message.

Forwarding option c: forward the received audio message to a storage space. In this case, user B will choose the appropriate IVR option(s) to forward the received message to a data space. The user's data storage space will be updated, including some explanatory text, and a URL/hyperlink link for the future retrieval of user A's audio message.

Forwarding option d: and multiple additional forwarding alternatives can be offered such as, for example, forwarding to an instant messaging user, to a voice messaging server, etc.

Upon receipt of the audio message, user B may decide not to reply with an audio message but instead to order the system to establish a phone call to user A. In this case, user B will choose the appropriate IVR option to request a call back to user A. Upon receipt of the call back instruction, the call back server will establish a call to the telephone number of user A and bridge the call together with the already established call with user B.

The originator of the message (user A) can configure to offer (or not) the message receiver (user B in this example) the opportunity to establish a call back. Such a control can be set by, for example, the sender either during message composition or as a default message setting on his client. Likewise, the originator of the message can configure to offer (or not) the message receiver the option to cover the cost of the call in case the receiver chooses to establish a call back.

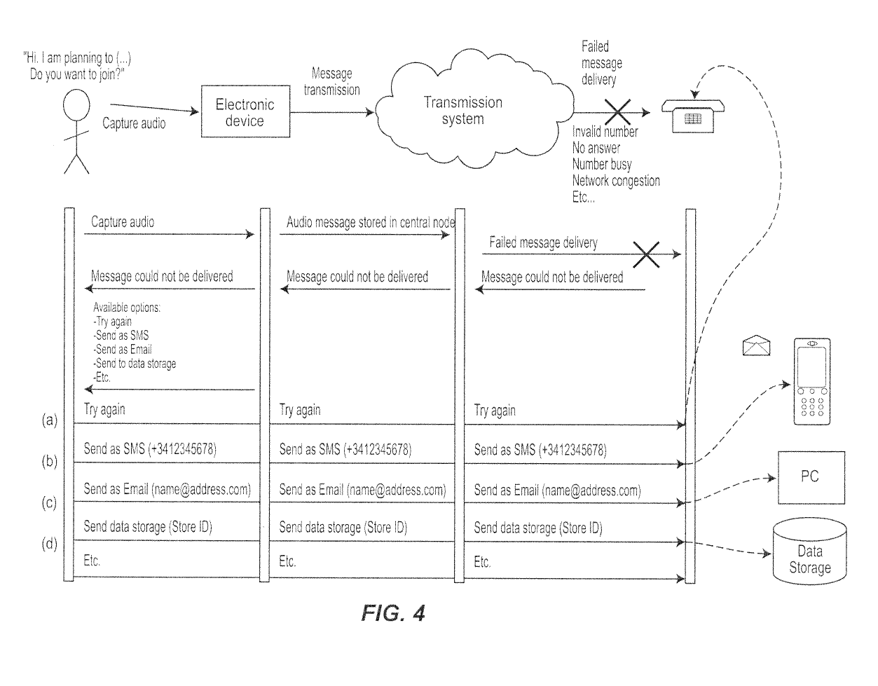

FIG. 3 shows a logical flow whereby user A sends a voice message to a telephone user after selecting (1) whether to record the audio message or retrieve an existing audio message, and (2) whether to send the audio message according to the system's default settings or to change some or all of them. In this exemplary embodiment of FIG. 3, the user can decide (i) to cover the cost of the call back in case the recipient uses that option, (ii) to disable the default possibility for the receiver to order a call back, (iii) to disable the default possibility for the receiver to forward the audio message, (iv) to disable the default possibility for the receiver to reply with a voice message, or (v) to enable the press-number response (press or say “1” to send “Yes”, press or say “2” to send “No” and press or say “3” to send “I don't know”).

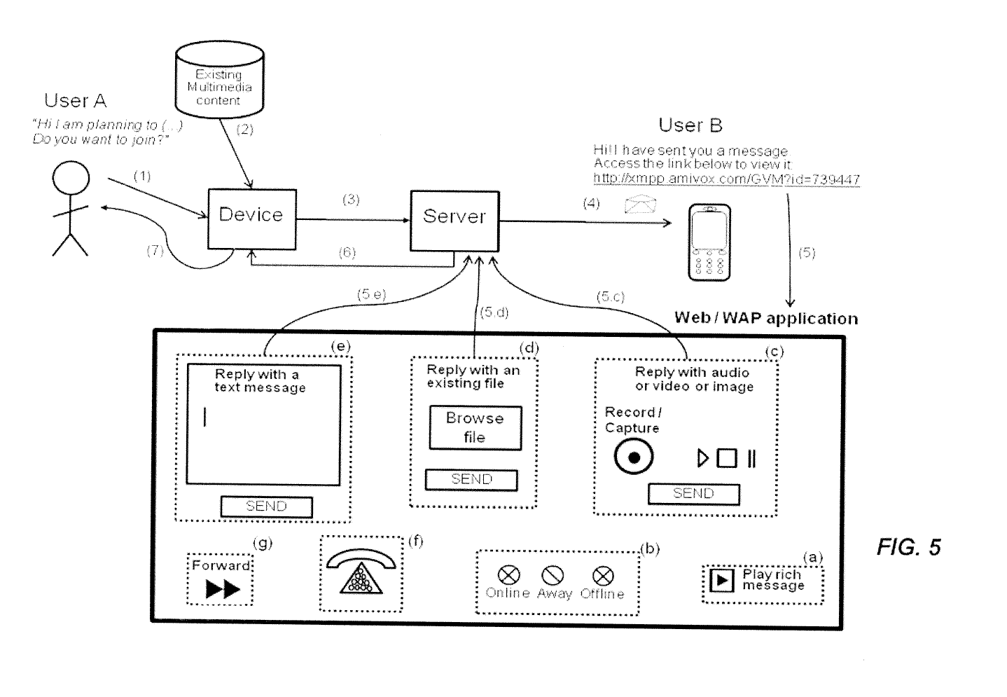

The sender (user A) can see in his client whether the receiver (user B) has answered the phone call and listened to the audio message. In case the call doesn't get answered by the receiver (no answer, invalid number, line busy, network congested, voice mail active, etc.) after the number of automatic call attempts set in the system, the sender will be notified and will have the opportunity to resume a call retry scheme or choose alternative means to deliver the audio message as seen in FIG. 4:

FIG. 4 is a flow diagram of an example of alternative means that a user has to deliver an audio message to a telephone user who didn't receive the micro call. Option (a) involves an attempt to deliver the message again, in which the IVR system resumes the call retry scheme. Option (b) involves sending the message as SMS/MMS, in which the audio message is sent as an SMS/MMS message (accessible via an URL/hyperlink) to user B's phone number. Option (c) involves sending the message as an email, in which the audio message is sent as an Email message (accessible via an URL/hyperlink) to user B's email address. Option (d) involves sending the message to a data storage, in which the audio message is sent to a data space. The user's data storage space will be updated, including some explanatory system text, and a URL/hyperlink link for the future retrieval of user A's audio message.

Thanks to this invention, traditional telephone users can join the instant messaging community via audio chatting. Likewise, state of the art text to speech technology can be used so that user A types his messages, which are subsequently delivered to user B as an audio file. In a similar manner, state of the art voice recognition technology can be used so that user B's voice messages can be delivered to user A as text transcripts, along with a hyperlink whereby user A can retrieved the stored original user B's audio file.

Traditional messaging and instant messaging services are not capable to deliver multimedia messages (multimedia messages with video and/or picture and/or audio and/or text) to SMS receivers. With the present invention, messaging users can compose a multimedia message and/or retrieve existing multimedia content and send it to any SMS/MMS user in the world so long they know the telephone number. The present invention also allows the SMS/MMS receiver of such a multimedia message to reply to the message with multimedia content and establish a chat session with the sender, or to forward the received multimedia message to a third destination, or to establish, via one click, a live call with the sender of the multimedia message.

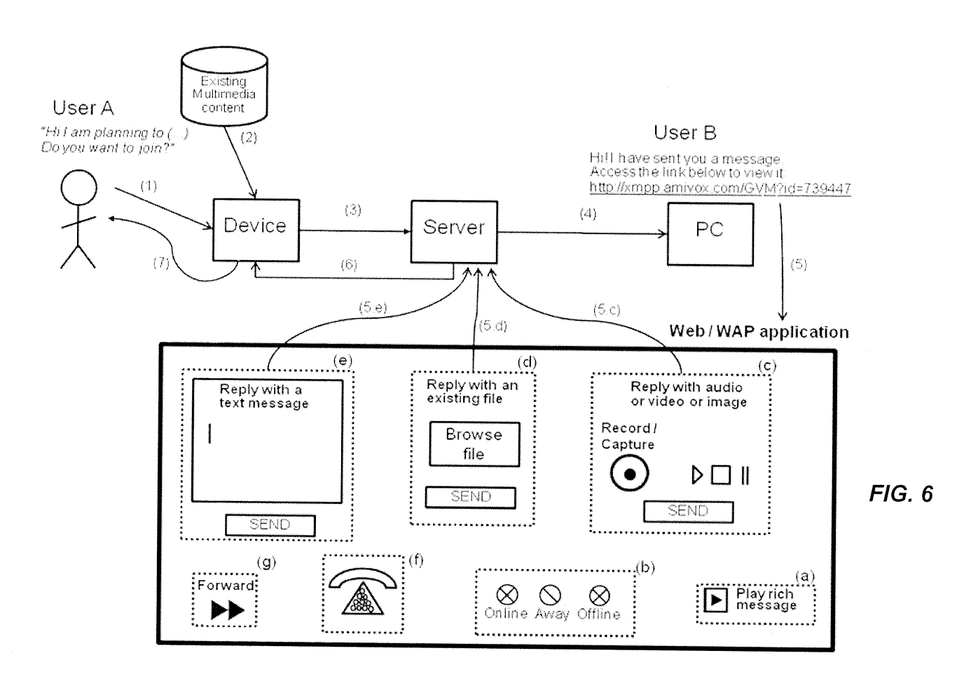

FIG. 5 shows a messaging user (user A) with an electronic device (Device) that delivers over a Server a multimedia message to a remote SMS/MMS user (user B) with traditional equipment that is able to receive SMS and/or MMS messages. As shown in FIG. 5, user A can compose the multimedia message in real time by recording audio and/or video, taking images and writing text. Alternatively, user A can, for example, access existing multimedia content (2). When user A sends the multimedia message to an SMS/MMS receiver (user B), his Device delivers the multimedia content to the Server (3) with the indication that it is to be transmitted to an SMS/MMS destination. The Server stores the content and generates a unique URL/hyperlink assigned to that content. The Server sends then an SMS/MMS message (4) to user B with an introductory text (e.g., “Hi! I have sent you a multimedia message, open the link below to view it”) followed by the unique URL/hyperlink that points to the stored message. In order for user B to recognize right away the origin of the SMS/MMS message, the system can be set to send the SMS/MMS message with user A's telephone number or alias name. When the receiver activates the URL or hyperlink of the received message, a web/wap environment opens FIG. 5 (5) from where the content is automatically retrieved and played. This browser environment provides the means for user B to reply with text, audio, image or video captured within the web/wap session or by simply uploading a file with the intended multimedia content.

As shown in FIG. 5, the web/wap environment contains a space (a) where the received multimedia message can be reproduced, a space (b) where the real time presence of the sender of the multimedia message (user A) is displayed, a space (c) whereby user B can record an audio/video message and send it back to user A, a space (d) whereby user B can retrieve existing multimedia content and send it to user A, a space (e) whereby user B can type text and send it to user A, a space (f) whereby user B can order a call back to user A, and a space (g) whereby user B can forward the received message to a third destination (e.g., email, SMS, MMS, etc.). User B can as well edit and send at once the aggregate of the contents in spaces (c), (d) and (e).

Referring to FIG. 5, in case user B sends a message back to user A from the web/wap environment to user A, it will be transmitted to the server (5.c), (5.d) and (5.e) and immediately forwarded by the server (6) to user A's messaging client provided that user A is online; otherwise it will be stored by the server for later delivery when user A resumes connectivity to the server. In case user B orders a call back (f), the order is transmitted to the server and forwarded to the Call Back server, which establishes the respective calls to users A and B and bridges them together. In case user B decides to forward the received message elsewhere 5 (g), the order will be transmitted to the server which will forward the message to the appropriate destination (some email address(es), some SMS/MMS receiver(s), receiver(s) of a micro call(s), receivers' data storages, etc.).

Thanks to the capabilities of the messaging client in the present invention, user A can as well do the editing [FIG. 5 (1) and/or FIG. 5 (2)] and sending action of the multimedia message while his client is offline (i.e., disconnected from the server). The multimedia message will be automatically submitted to the server FIG. 5 (3) for delivery to the intended recipient(s) immediately after the client has become online (i.e., connected to the server). The sender (user A) can see in his client whether and when the receiver (user B) has retrieved the SMS/MMS message since the unique URL associated to user A's message is tagged, and when user B retrieves the content, user A can be notified in real time by the system. In case the SMS/MMS doesn't get delivered to the mobile phone, the sender (user A) can be notified in his client and will have the opportunity to retry sending or choose alternative means to deliver the multimedia message (e.g., as a micro call, to an email account, to an IM receiver, to a storage server, to another mobile phone user as an SMS/MMS, etc.).

Thanks to this invention, mobile users can join an instant messaging facility without need to install any specific software on their terminal equipment. In accordance with the exemplary embodiment shown in FIG. 5, upon activation of the browser link received in the SMS/MMS message, user B establishes a live multimedia chat session with user A without having downloaded any software client in his device. Likewise, this invention allows the receiver of the SMS/MMS message (user B) to visualize in real time the presence of the sender (user A). User B may open the message with a significant delay after it was sent, and thanks to the provided presence information user B knows right away whether user A will receive his response at that moment or whether it will be stored for later delivery.

Traditional messaging and instant messaging services are not capable to deliver multimedia messages to Email receivers. With the present invention, messaging users can compose a multimedia message and/or retrieve existing multimedia content and send it to any Email user in the world so long they know the email address. The present invention also allows the Email receiver of such a multimedia message to reply to the message with multimedia content and establish a chat session with the sender, or to forward the received multimedia message to a third destination.

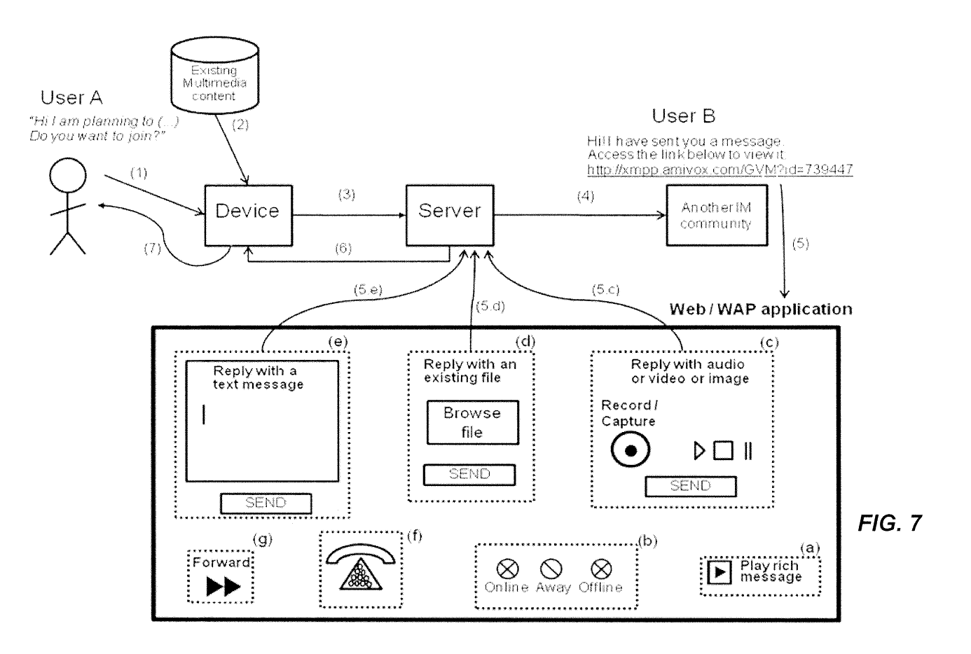

FIG. 6 shows a messaging user (user A) with an electronic device (Device) that delivers over a Server a multimedia message to a remote Email user (user B). User A's electronic Device has the instant messaging client of this invention. The receiver (user B) is an Email user (from a computer, PDA, mobile phone, browser, etc.).

As shown in FIG. 6, user A can either compose the multimedia message in real time by recording audio and/or video, taking images and writing text FIG. 6 (1), or he can access existing multimedia content FIG. 6 (2). When user A sends the multimedia message to an Email receiver (user B), his Device delivers the multimedia content to the Server FIG. 6 (3) with the indication that it is to be transmitted to an Email destination. The Server stores the content and generates a unique URL/hyperlink assigned to that content. The Server sends then an Email message FIG. 6 (4) to user B with an introductory text (e.g., “Hi! I have sent you a multimedia message, open the link below to view it”) followed by the unique URL/hyperlink. In order for user B to recognize right away the origin of the Email message, the system can be set so that the server sends the Email message with user A's Email address set as the email's sender or with user A's alias name visible in the Subject or Body of the Email message.

When the receiver opens the URL or hyperlink of the received message, a web/wap environment is launched FIG. 6 (5) from where the content is automatically retrieved and played. This browser environment provides the means for user B to reply with text, audio, image or video captured within the web/wap session or by simply uploading a file with the intended multimedia content. As shown in FIG. 6, the web/wap environment contains a space FIG. 6 (a) where the received multimedia message is reproduced, a space FIG. 6 (b) where the real time presence of the sender of the multimedia message (user A) is displayed, a space FIG. 6 (c) whereby user B can record an audio/video/image message and send it back to user A, a space FIG. 6 (d) whereby user B can retrieve existing multimedia content and send it to user A, a space FIG. 6 (e) whereby user B can type text and send it to user A, and a space FIG. 6 (g) whereby user B can forward the received message to a third destination (e.g., email, SMS, MMS, etc.). User B can as well edit and send at once the aggregate of the contents in spaces FIG. 6 (c), FIG. 6 (d) and FIG. 6 (e).

Used B can as well decide to establish a call back to user A. In this case, when user B selects the call back option FIG. 6 (f), the web/wap environment prompts him to enter the telephone number where he shall be called, and the order is transmitted to the server and forwarded to the Call Back server, which establishes the respective calls to users A and B and bridges them together. In case user B sends a message back to user A from the web/wap environment, it will be transmitted to the server [FIG. 6 (5.c), FIG. 6 (5.d) and FIG. 6 (5.e)] and immediately forwarded by the server FIG. 6 (6) to user A's messaging client provided that user A is online; otherwise it will be stored by the server for future delivery when user A resumes connectivity to the server.

Thanks to the capabilities of the instant messaging client in the present invention, user A can as well do the editing FIG. 6 (1)-FIG. 6 (2) and sending action of the multimedia message while his client is offline (i.e., disconnected from the server). The multimedia message will be automatically submitted to the server FIG. 6 (3) for delivery to the intended recipient(s) immediately after user A's client becomes online (i.e., reconnected to the server). The sender (user A) can see in his client whether and when the receiver (user B) has retrieved the Email message (i.e., whether user B has opened the unique URL/hyperlink link received in the Email).

Thanks to this invention, email users can join an instant messaging facility without need to install any specific software on their electronic equipment. In the example in FIG. 6, upon activation of the browser link received in the Email message, user B establishes a life chat session with user A without having downloaded any software client in his computer. Likewise, this invention allows the receiver of the Email message (user B) to visualize in real time the presence of the sender (user A). User B may open the message with a significant delay after it was sent, and thanks to the presence information user B knows right away whether user A will receive his response at that moment or whether it will be stored for later delivery.

Traditional messaging and instant messaging services are not capable to deliver multimedia messages to other instant messaging communities. For example, a Skype user cannot send a video message to a Yahoo instant messaging user. With the present invention, messaging users can compose a multimedia message and/or retrieve existing multimedia content and send it to an instant messaging user from another community so long there is a traditional instant messaging gateway (text support is sufficient) between both communities. The present invention also allows the instant messaging receiver of such a multimedia message to reply to the message with multimedia content and establish a chat session with the sender, or to forward the received multimedia message to a third destination.

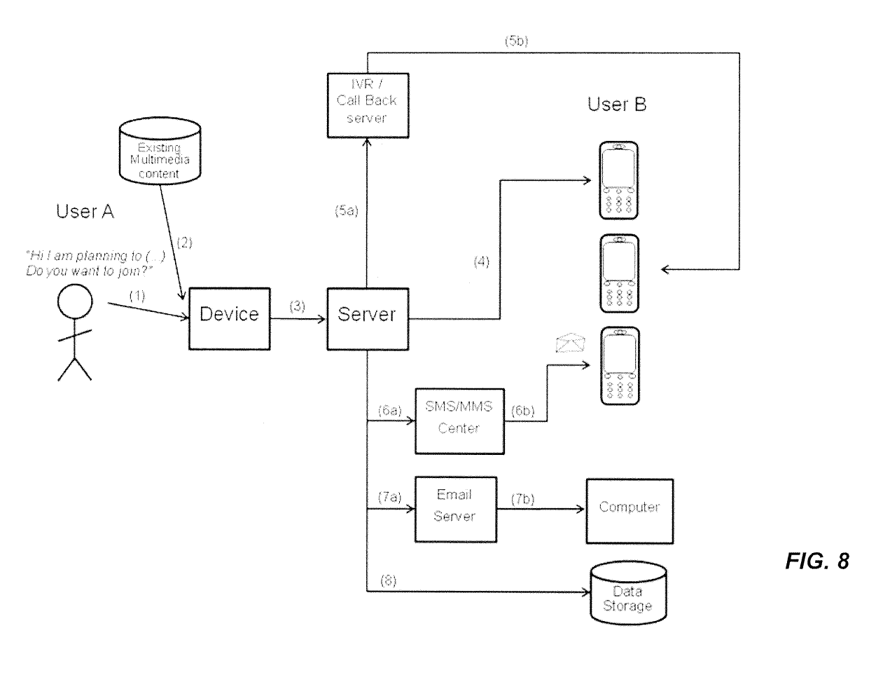

FIG. 7 shows a messaging user (user A) with an electronic device (Device) that delivers over a Server a multimedia message to a remote instant messaging user (user B). The receiver (user B) is an instant messaging user from a different messaging community than user A's. User B can be using any public instant messaging community such as Microsoft Life Messenger (MSN), AOL, Yahoo, Gtalk, Skype, ICQ, Mig33, eBuddy, etc. As shown in FIG. 7, user A can either compose the multimedia message in real time by recording audio and/or video, taking images and writing text FIG. 7 (1), or he can access existing multimedia content FIG. 7 (2). When user A sends the multimedia message to the instant messaging receiver of another community (user B), his Device delivers the multimedia content to the Server FIG. 7 (3) with the indication that it is to be transmitted to an instant messaging destination. The Server stores the content and generates a unique URL/hyperlink assigned to that content. The Server sends then a text instant message FIG. 7 (4) to user B with an introductory text (e.g., “Hi! I have sent you a multimedia message, open the link below to retrieve it”) followed by the unique URL/hyperlink.

When the receiver opens the URL or hyperlink of the received message, a web/wap environment opens FIG. 7 (5) from where the content is automatically retrieved and played. This browser environment provides the means for user B to reply with text, audio, image or video captured within the web/wap session or by simply uploading a file with the intended multimedia content. As shown in FIG. 7, the web/wap environment contains a space FIG. 7 (a) where the received multimedia message is viewed, a space FIG. 7 (b) where the real time presence of the sender of the multimedia message (user A) is displayed, a space FIG. 7 (c) whereby user B can record an audio/video/image message and send it back to user A, a space FIG. 7 (d) whereby user B can retrieve existing multimedia content and send it to user A, a space FIG. 7 (e) whereby user B can type text and send it to user A, and a space FIG. 7 (g) whereby user B can forward the received message to a third destination. User B can as well edit and send at once the aggregate of the contents in spaces FIG. 7 (c), FIG. 7 (d) and FIG. 7 (e).

Used B can as well decide to establish a call back to user A. In this case, when user B selects the call back option FIG. 7 (f), the web/wap environment prompts him to enter the telephone number where he shall be called, and the order is transmitted to the server and forwarded to the Call Back server, which establishes the respective calls to users A and B and bridges them together. In case user B sends a message back to user A from the web/wap environment, it will be transmitted to the server [FIG. 7 (5.c), FIG. 7 (5.d) and FIG. 7 (5.e)] and immediately forwarded by the server FIG. 7 (6) to user A's messaging client, provided that user A is online; otherwise it will be stored for delivery when user A resumes connectivity to the server.

Thanks to the capabilities of the instant messaging client in the present invention, user A can as well do the editing FIG. 7 (1)-FIG. 7 (2) and sending action of the multimedia message while his client is offline (i.e., disconnected from the server). The multimedia message will be automatically submitted to the server FIG. 7 (3) for delivery to the intended recipient(s) immediately after the client has become online (i.e., connected to the server). Likewise, deferred sending is a possibility supported by this invention.

For any of the message types described above (in FIG. 1-FIG. 7) and throughout this document, the user can decide to send the message with an indication of when in the future the actual transmission shall be triggered from the server to the recipient(s). In case he decides so, the sender sets the timing for the message delivery through an interface in his client. For example, a user may decide to send a voice message as a micro call to his grandmother's home telephone number to congratulate her for her birthday (to take place the day after), and set the message to be delivered “tomorrow at 09.30 am”. Another example can be a teacher composing late in the evening a message which shall be delivered “tomorrow at 8.30 am” to all students' email addresses to give them instructions for the homework of the day. Messages can be set with a deferred delivery from several seconds up to several months or years. At the selected time in the future, the message is then delivered by the server to the intended recipient(s) and in the intended form (micro call, SMS/MMS, email, public IM, etc.).

The previous portions sections of the present invention have covered the means by which messaging users can establish multimedia chats sessions with other messaging platforms such as email, SMS, MMS and different community IM services. It should be recognized that the same mechanism provided by this invention would be applicable to, for example, any other messaging platforms that enable the sending and/or receiving of any kind of electric messages.

The present invention provides a system solution to intelligently deliver messages to the intended destination(s) and over the specific channels according to the status of the receiver(s) and according to a specified order of priorities. With nowadays communications, when a user A wants to send a message to a user B, user A needs to select the delivery channel of choice. Exemplary delivery channels are Email, SMS, phone call, instant message, MMS, etc. The present invention allows, for example, the system administrator or the user to determine the order of priorities how a message shall be delivered according to the receiver's status.

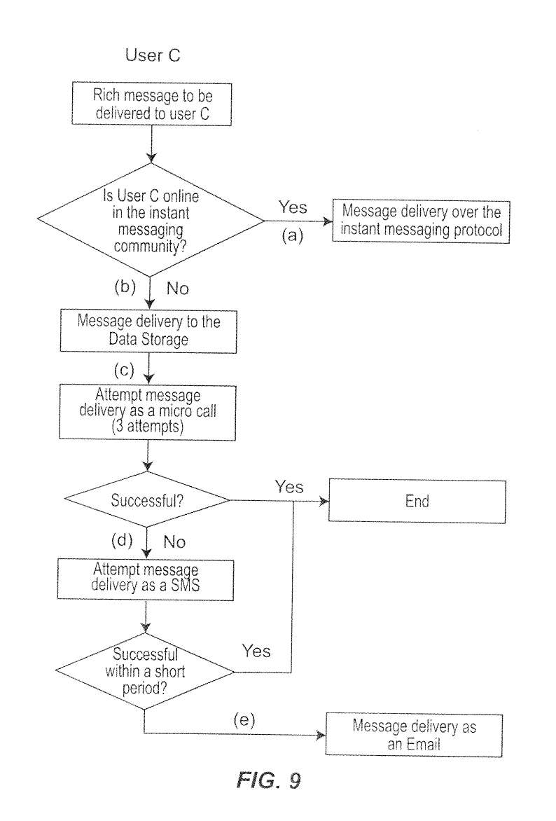

FIG. 8 shows a messaging user (user A) with an electronic device (Device) that delivers to the Server a multimedia message for delivery to user B. User A's electronic Device has the instant messaging client of this invention. The receiver (user B) is registered in the Server and hence data such as his phone number and his email address are available to the system. As shown in FIG. 8, user A can either compose the multimedia message in real time by recording audio and/or video, taking images and writing text FIG. 8 (1), or he can access existing multimedia content FIG. 8 (2).

One advantage of the present invention is that, when user A sends the multimedia message to user B, he neither needs to care about the presence status of the receiver, nor must he select whether the message shall be transmitted as an instant message, or as a micro call, or as an SMS/MMS message, or as an email or whether it should be stored in user B's Data Storage. This is thanks to the fact that either the messaging client in the Device and/or the Server can be programmed to handle the message transfer as shown in the following exemplary manner:

Note: the sequence below is explained assuming that the intelligence regarding the different actions resides in the server. It must be mentioned that the scope of this invention also covers the implementation of this logic within the Device's software. In this regard, the software can be incorporated into the Device when it is sold to an initial end user or can be later downloaded by a client from a suitable wireless network. In the case of the Device being a personal computer or laptop, then the software would be installed as a pre-loaded application or downloaded from a website. If Device were a hand-held communication device such as, for example, a PDA or smartphone (e.g., an Apple iPhone or a Blackberry Bold), the software could be stored in a program memory of the device, and executed by the Device's processor in connection with appropriate memory and communication circuitry.

In any event, user A's Device transmits the multimedia message to the Server FIG. 8 (3). If user B is online in the instant messaging community, the Server will deliver the multimedia message over the instant messaging protocol and user B will immediately receive it in his device's client FIG. 8 (4). If, however, user B is offline in the instant messaging community, the Server will transmit the audio portion of the multimedia message to the IVR Server FIG. 8 (5a) and make, for example, three call attempts to user B's telephone number FIG. 8 (5b) (see FIG. 1, FIG. 2 and FIG. 4). If after the call attempts the message has not been delivered (no answer, line busy, congested network, voice mail active, etc.), the Server will transmit the multimedia message to the SMS/MMS Centre FIG. 8 (6a) to deliver the message to user B as an SMS/MMS message FIG. 8 (6b) (see also FIG. 5). If the SMS/MMS message fails to deliver to user B's phone within a short period (for example, within 15 seconds from sending the message), the Server will transmit the multimedia message to the Email Server FIG. 8 (7a) to deliver the message to user B as an email message FIG. 8 (7b) (see also FIG. 6). The system can be set so that all messages, whatever the final delivery form to user B becomes, get forwarded to the Data Storage associated to use B's account FIG. 8 (8).

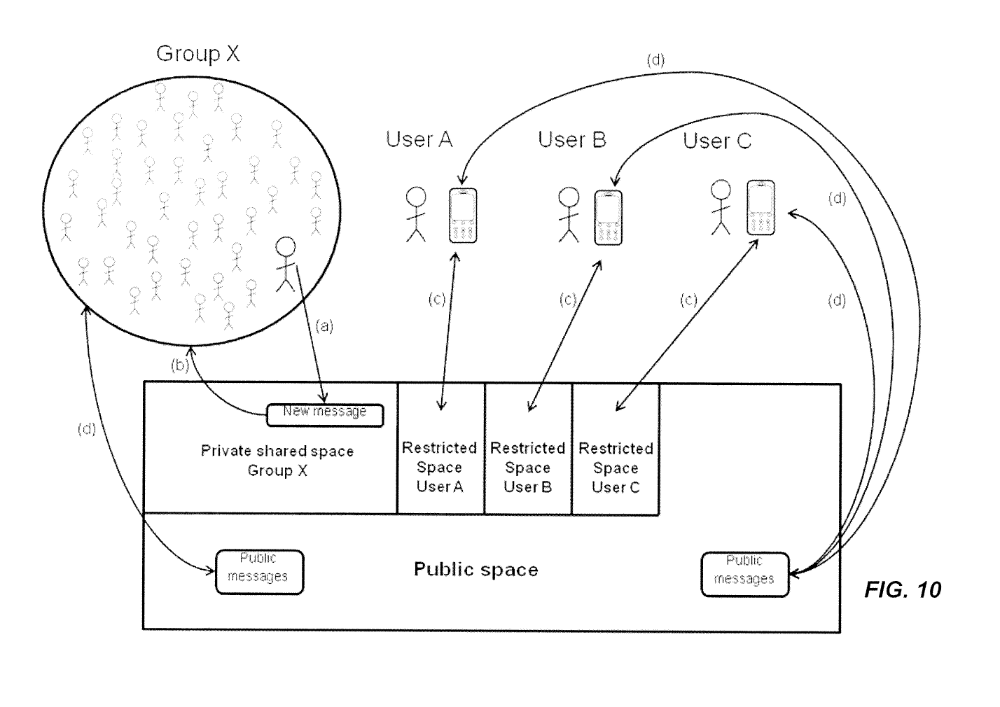

The system can be pre-programmed with whichever delivery priorities the system administrator determines, or it can be left down to the end users' choices. For example, as shown in FIG. 9, a user C may decide that the order of delivery is first to the receiver's mobile instant message if he is online FIG. 9 (a); otherwise a copy of the message shall be placed in the receiver's Data Storage FIG. 9 (b) and three attempts shall take place to deliver the audio portion of the multimedia message as a micro call FIG. 9 (c); if the message delivery over micro call fails, the message shall be sent as an SMS message with delivery notification FIG. 9 (d); if the SMS message does not get delivered within a short period, the message shall be sent as an email FIG. 9 (e).

The applicability of this invention is very appropriate for specific segments such as, for example, young children users, senior users or disabled users. These users may not have the capability to understand and control the multiple communication channels that can be used at any time to reach their correspondents (family in most cases). Likewise, their relatives and friends may want to make sure that messages from these users do always get delivered to them no matter what. With the present invention, messages sent by the specific user class (e.g., young children users, senior users or disabled users) follow a specific delivery protocol defined in the system, thereby the messages will always get delivered via one or more channels to the at list one intended recipient. As a result, the user interface for the specific user class can still be based on a classic buddy based list of contacts, whereby users must not be sorted in the traditional online vs. offline contacts. Instead, the list of contacts can be a static list that does not provide presence information since the message delivery will always take place regardless whether the receiver is online within the instant messaging community or not.

This invention is also applicable for users who decide to receive messages according to a specific logic defined by them. These users will be set in the Server's data base with a flag so that any instant message addressed to them is handled according to the specified delivery priority scheme (e.g., instant message if online, SMS if busy, data storage plus micro call if offline, etc).

Messaging communication between users in a mobile network is mainly bound within the core network platforms like SMSC and MMSC or via real time communication platforms like the call switches, mobile IP nodes, etc. Standard IM services like MSN, AOL etc. in essence focus on real time messaging services. Access to external services or external communication platforms is, in most cases very limited or not at all possible.

In a typical mobile network there is, in most cases, a variety of different value added services available for users. Access to these services is either from WAP or messaging services such as SMS/MMS/email, via traditional telephony services (IVR) or via a web page. Most of these services are based around content access, such as retrieval of information, ring tones and logos or video downloads or web page retrieval. Mobile IM solutions available today open up for PC-like IM services in mobile devices. However, the relation to other mobile value added services or content access is not considered.

The present invention is an expansion of the value added service domain. Such an expansion allows the user to create new ways to communicate and make a strong link between value added services and traditional communication. One of the key elements for this expansion is the buddy list. A buddy list in the client usually is the main communication view for an instant messaging user. One advantage of the present invention offers, for example, the means to access content and value added applications via a traditional buddy based communication with the use of virtual buddies. In essence, some of the buddies in the buddy list can be links towards value added services or information sources. This is a new way of linking a buddy in a buddy list to a not-human entity. Such a buddy can be called a “virtual buddy”.

In accordance with one embodiment of the present invention, the “virtual buddy” is stored as a contact in a user's electronic device (e.g., computer or smartphone), with the software disclosed herein being installed as an application therein. Alternatively, the virtual buddy could be stored in memory at a server with which the electronic device communicates by means of an internet connection.

An example can be a user who submits to a virtual buddy a voice message that the system automatically directs to a speech recognition system. In this example, the service behind the application could be an automatic phone directory service request, specially created to process inquiries like “who is the owner of the mobile number xxxx”, or “find me a hotel in Boston for two nights in the middle of June”, or a home security system which would authenticate and execute a voice message like “Open the door” etc.

Individuals and organizations often broadcast via email or similar messaging services information which is of little value to many of the receivers such as “who is the owner of the car parked on . . . ” or other similar temporal information. These messages are often sent out as an email to all employees, or placed in the company's intranet page, or even put as a paper poster on a wall somewhere within the company.

The present invention is similar to the traditional message boards with hanging paper messages that one finds everywhere such as in a central area in a college, in a company, in the bakery, etc. In those traditional message boards, people typically hung ads or notices and anybody curious decides when to go and check whether there is something of interest to them. In a similar manner, users of this invention's message board decide when to check their message boards to look for information or to post their own entries.

According to one aspect of the present invention, groups of users can communicate efficiently among themselves. In this manner, users can post their audio/image/video/text multimedia messages to the shared space (message board), which can be subsequently retrieved by the other group members at their convenience.

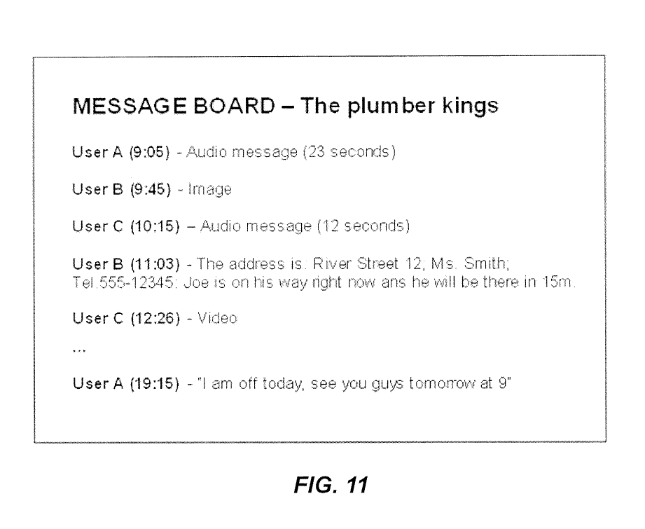

FIG. 10 (a) shows how a particular user within a Group X (which can be a corporation, a group of friends, group of interest, etc.) posts a message into the private shared space of Group X. The remaining members of Group X will have access to this message [FIG. 10 (b)] since their user-ids within the messaging community are registered as part of Group X. FIG. 10c shows how users can send and retrieve messages to and from their restricted spaces. A user with a restricted space is the only user allowed to post messages to that space, and he can determine the individuals who have access to view the content posted there. All users can post messages to the public space, and view any posted messages FIG. 10d.

Users belonging to a group within a message board can receive an audio, a vibrating and/or visible alert for new messages posted to the group's board, and they can retrieve the posted messages directly from the clients in their electronic devices or from the internet. According to the device's user interface, users may decide upon the alert type they receive for new messages that have been posted into a message board they are subscribed to (either per message event or a periodical reporting of any new message events within a given period). Users may also decide to not receive any alerts. Alerts can be of an audio nature, a vibrating nature, or of a visual nature. For example, a banner (ticker) can scroll at some place on the display with information regarding the message board event. The text and/or background of the banner can also adopt different colors or sizes or scrolling speeds or blinking effects according to the nature of the messages. For example, a general information ticker containing weather data, traffic data, etc. can have a traditional appearance (e.g., white background, black text, no blinking and scrolling in a default speed) but when a new entry to the message board occurs some or all of the characteristics of the traditional appearance change to notify the new entry.

An important characteristic of the present invention's message board is that users can, for example, post messages into the at least one group they belong via a virtual buddy within their buddy list. Accordingly, a user who belongs to the group “X” will have a buddy in his buddy list referring to that particular message board. To post a message to the group “X”, the user will simply compose a multimedia message and send it to the virtual buddy representing this message board's group. The messaging system can be programmed so that messages sent to this particular virtual buddy are automatically posted as entries into the group “X” of the message board, and assigned the sender's identification. The system can be set so that virtual buddies representing message board groups are always online. Likewise, the system can be defined in such a way that virtual buddies representing message board groups appear automatically in the buddy lists of those users who are assigned to the group (e.g., employees within an organization). The virtual buddy can also indicate whether new entries have arrived to the group's message board, the number of new messages, etc. Access to the complete list of entries within the group's message board can be accessed directly from the buddy list by clicking on some menu or submenu associated to the virtual buddy. In a possible implementation, the latest 10 entries can be accessed by clicking on the virtual buddy, and older entries can be accessible with an additional single click.

Thanks to the message board proposed in this invention, groups can efficiently and non-obtrusively communicate by submitting at any time audio/image/video/text multimedia messages to their shared space with a single click and via a well known interface: the composition and sending of messages to a buddy. This way, users do not need to get used to yet another interface to access the message board communication means. As an example, a team of plumbers within an organization can spend the day going from destination to destination without need of placing or receiving calls to and from the central office or between themselves to notify about the completion of a work task and requesting about the next destination. With this invention's message board, the plumbers will simply post messages from their mobile devices to the message board's virtual buddy when they have completed a work task. After that, they will be able to find in the message board instructions regarding the next work task to accomplish. On top of traditional text messages, the system also allows the plumbers to post image/video/audio messages so that the rest of members can receive valuable rich data (e.g., video of a broken piece that requires replacement or a detailed voice recording of the repair action taken) in a much more thorough and exact manner than via a text message or a call.

Moreover, all communication is stored in the message board, allowing for a later retrieval thereof. Likewise, users can select parts of the content posted in the message board (individual entries) and forward it as a micro call (the audio portion of the message), or directly as an instant message to a buddy, or as a URL/hyperlink link to a public IM buddy, SMS/MMS, email address, etc.

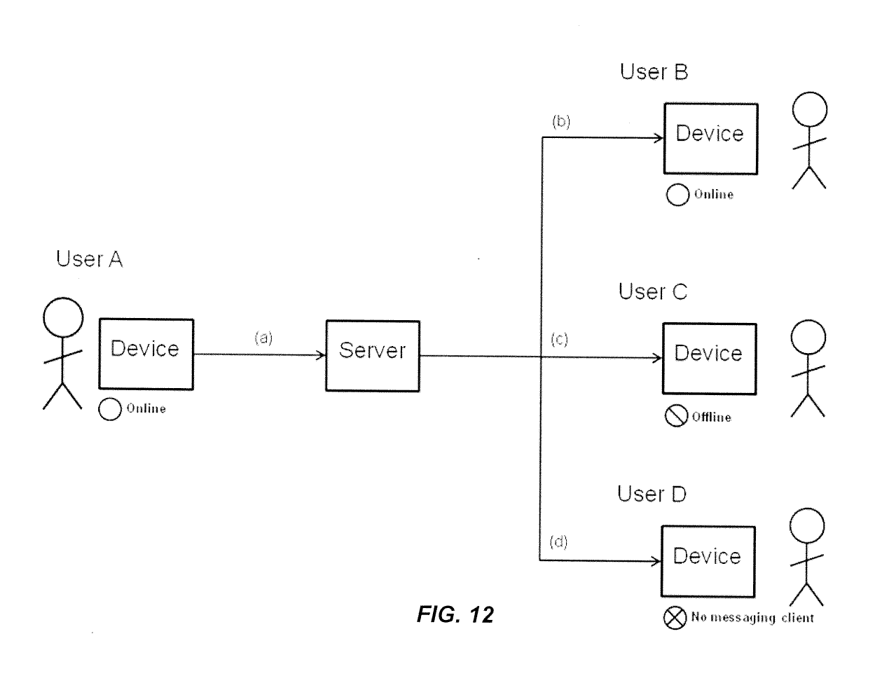

With the proposed non-obtrusive message board, users will not be constantly receiving email, calls or other messages to alert them about new events. Instead, they will decide when to look into the message board to receive a status and post their own content FIG. 11.

Thanks to the nature of this invention, communication via the message board is visible to all group members, making it possible for all parties to be informed in real time and act if they decide so (e.g., plumber “A” suggesting that he can take the assignment of plumber “B” as he is at a much shorter distance from the destination). Likewise, if two of the parties decide to have a parallel discussion, not accessible to the rest of the group members, they can easily do so by stopping to post messages via the virtual buddy and moving to a direct buddy-to-buddy messaging within the same instant messaging interface.

The present invention enables a very efficient group communication of audio/image/video/text multimedia content in a non-obtrusive manner to the group members and very cost efficient given the fact that users dramatically minimize the number of call and message events to keep all group members informed. Messages in the electronic message board can have different prioritization and therefore it is possible to tag messages as important. The invention allows a traditional paper or poster message board to be put in an electronic mobile form and thereby save space, paper and money. Users can create on the run message boards and invite others to join them. A message board can be open to everyone, closed to a certain group, or open to everyone with certain exclusions.

Many individuals have, over the last few years, created their own blog areas or have been hosting some web-pages where they share and express their experience and opinion on a very regular and frequent basis. Management and content editing of these spaces is done today almost exclusively via PC access. As an example, this means that a user, who is travelling around the world and blogging about his experience, needs to regularly go to an area where he has access to a computer. For typical bloggers, the blogging or web page editing usually needs to take place in front of a computer at home in the evening or during work hours. Moreover, the content on these pages is in most cases only text or pictures.

The present invention mobilizes the blogging actions and adds multimedia content (audio, image and video) as a critical entity into the blogging space. With the current invention it is possible to post and manage blogs directly from this invention's instant messaging client. The client allows the user to compose multimedia content and send it to the server for storage with one single click. Blogs (blogcasts) are dynamically created on the fly when the proper request is made to the server by an external application attempting to reproduce the content. For reporters or someone frequently operating out on the field, this mobile and rich content creation method can be crucial to their reporting efficiency.

An important characteristic of the present invention's blogcast is that users can, for example, post entries by composing messages via a virtual buddy within their buddy list. Accordingly, a user will simply compose a multimedia message and send it to the virtual buddy representing his blogcast. The messaging system can be programmed so that messages sent by this user to this particular virtual buddy are automatically posted as entries into his blogcast space.

With this methodology, the user's multimedia content can be presented as a blogcast framework that combines the messaging functionality of the client, the website technology, and user access control. The invention provides, for example, a very simple user interface for users to add entries to their blogcasts while they are on the run. For example, a mobile user can take a picture, record a voice message and write a title for the blogcast entry and send it as a blogcast following the proper menu options in the messaging client. The client will subsequently send all the content to the server, which will be stored in the proper web space associated to the user. With the present invention, users have a very easy and convenient means to add real time content to their blogcast space.

The website can be a public website (i.e., open to anyone), or have an access control (i.e., open only to those people white listed by the administrator), or closed to only the administrator. Likewise, blogcast entries can be set to be accessible only within an intranet environment (e.g., only for employees of a specific company).

The viewing of this invention's blogcast can be done from an internet browser, from a television device, or directly from this invention's client or any standard podcast receiver. In all cases, accessibility can be open for everyone or limited to specific individuals or groups. Posted messages can be displayed in several sequential forms such as according to their chronology, according to size, priority, etc. From the messaging client, users can select a given buddy and view all his public blogcasts on the run and with very few key presses or clicks.

The system can be set in such a manner that users get automatically notified when a blogcast entry has been submitted by any of their instant messaging buddies. This way, if they decide so, users can access to new blogcast entries as they occur and within the well known instant messaging interface. Users viewing other users' blogcasts can make comments to individual entries. Comments can be submitted as text, audio, image or video. A blogcast can be shared between several users. For example, family members can post messages into the same blogcast space. Those accessing their blogcast will be able to view the aggregate content of the family members.

The present invention allows users to easily create and maintain a history line of their own day-to-day life experiences by capturing content with their mobile devices and submitting it directly from their instant messaging client. The content can be accessed in a user friendly mode, with a hair-line indication of the time when the different content inputs were submitted, with continuous and smooth transitions between content inputs and with functionality that enables forwarding, rewinding, pausing, etc. This way, users can easily view the history line of a user or group of users that have been creating this personal content of historic nature. A typical example would be a family where the parents, over a number of years, capture and transmit with their mobile phones images/audio recordings/video of their children and family life and upload them with 1-click thanks to this invention's messaging client.

One of the key drawbacks of all IM based (buddy based) communication systems is the requirement of buddy acceptance before the communication can be established. This behavior is one of the key elements in buddy-based communications systems. For communications which are intended to be one-off sessions, or which do not intend to build a long term buddy relationship, buddy acceptance is often an unwanted process for the end users. Typically, removing a person out of a buddy list can be perceived like a bit offensive or drastic procedure. At the same time, in traditional chatting systems the fact of knowing the mobile telephone number of a person is not sufficient to establish a chat session; on the contrary, a buddy relationship must exist beforehand. Without the one-off chat process proposed in this invention, buddy lists risk filling out with contacts who day aren't friends that the user necessarily wants to have as perpetual messaging buddies and with whom to share presence information.

This present invention also allows mobile users to establish a mobile one-off chat session over the instant messaging protocol despite of not being able to access each other's presence. In traditional instant messaging applications, the server maintains the updated presence status of the community users. This way, the server can propagate the presence status of a certain user to the rest of buddies of that particular user. With the present invention, a user can be set in a state that does not exchange presence information with the server but still is willing to participate in sporadic chat sessions with other users. Likewise, a user may want to establish a chat session with another user that is not in his buddy list and whom he does not want to add to the list (e.g., a business man establishing a one-off chat session with a potential supplier).

In situations like the ones described above, a user can access a dedicated one-off chat menu within the messaging client by inviting a user (or a number of users) to participate in a one-off chat session, and submit the Chat-Subject (text/audio/image/video) that he wants to send to that (those) user (s). The Chat-Subject and the information (mobile telephone numbers) of those invited are transmitted to the server. To those receivers that their presence status is known of and which are on-line, the server sends a chat invitation request over the instant messaging protocol including information of the inviter and the initial Chat-Subject submitted by him. To those receivers the presence status isn't know of or those who are known to be off-line, the server sends a chat invitation request packed over an SMS/MMS message including information of the inviter and the initial Chat-Subject submitted by him (directly as text or as a URL/hyperlink link in case of audio/image/video).

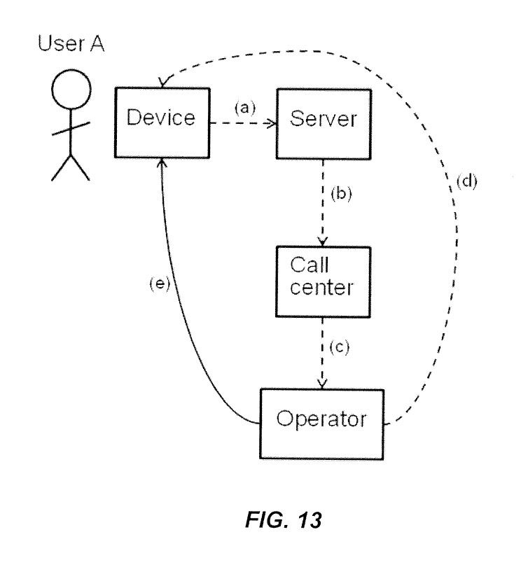

FIG. 12 shows users A and B who are online, a user C who is in offline state, and a user D who is not in the instant messaging community. User A doesn't have users B, C or D in his buddy list, but he happens to know the mobile number of the three of them. User A decides to establish a one-off chat request to users B, C and D by sending the invitation request to the three mobile telephone numbers FIG. 12 (a). Upon receipt of the request, and based on the three mobile telephone numbers, the server identifies users B and C within the community and determines that user D is not a user within the messaging community. Since user B is online, he will receive the one-off chat invitation directly into his messaging client FIG. 12 (b) and his device will alert him about it. Since user C is not online in the messaging server, he will receive an SMS/MMS message with a notification about the one-off chat request FIG. 12 (c), and a request to open the messaging client in order to access the chat room. Since user D is not in the messaging server's community, he will receive an SMS/MMS message with a notification about the one-off chat request FIG. 12 (d) with a hyperlink to join the one-off chat room (as explained in FIG. 5).

Those users B, C or D in FIG. 12 who accept the one-off chat invitation will be able to communicate via instant messaging with the rest of users (user A and any others who have joined the one-off chat session) despite of the fact of not being buddies with one another (hence not sharing presence information). Once they leave the one-off chat session, their personal buddy lists won't include the users that participated in the one-off chat, and hence they won't share future presence information.

In all cases, the chat invitation request can also contain, for example, some predefined text clarifying that the sender intends to establish a chat session. The sender can decide not to add any subject in the initial invitation message, in which case the receiver will get a chat invitation request informing of the sender's id and that he is inviting him to participate in a one-off chat session.

This invention also considers the case in which one of the invitees accesses the chat in a deferred mode (i.e., sometime after the chat session was started or even after the rest of the participants have left it). In this case, the history of the chat session will still be accessible to the deferred participant. Content entries can be viewed in association to the ID of the users submitting them as well as the times of submission. One of the key elements of the one-off chat is that users who are not buddies have no residual information on each other's presence or future activities after the chat has ended.

Running an effective and good quality call centre is typically one of the biggest headaches of service companies. Many companies face the problem that their call centers or telephone help desk centers get saturated at certain peak times. This typically results in long waiting times for the callers until an agent is finally available to take their call.

This situation is usually addressed in different ways: by increasing headcount in the call centre, hence increasing operational cost; by outsourcing the call centre activity, hence moving the cost elsewhere and loosing direct access to customers' feedback; by purchasing and deploying technology such as IVR, voice recognition engine, etc. (the acquisition and maintenance cost of such systems can be quite expensive); etc.

The present invention proposes an environment where users have access to a messaging client that enables them to send multimedia content messages in multiple forms and at any time. Thanks to this invention's technology, users can communicate with multimedia messaging with call centers in a very efficient form for both the user and the organization responsible for the call centre. On the one hand, users can submit messages at any time and without having to wait until an agent is ready to take their call, and without having to wait on the phone while the call centre's agent is resolving the issue (e.g., when asking for a certain telephone number or address). On the other hand, the company running the call centre will be able to process the received message according to their own resource capacity and respond to them at their own pace. And general purpose responses can be sent as a broadcast to many users at the same time.

The present invention allows users to submit multimedia messages from their instant messaging client (e.g., a voice recording from a mobile phone, or a voice recording plus a picture) for example when dealing with the call centre of the insurance company about damages in their house. The response from the call centre to the user can be in several forms:

Response form a—voice message sent to the user's client: a spoken message response by the agent (e.g., booking and time confirmation for the next visit to the dentist); the user can process the received message at any time he pleases.

Response form b:—audio message sent to the user's client: an audio recording (e.g., a pre-recorded system message explaining the driving directions to get to the airport); the user can process the received message at any time he pleases.

Response form c—text message sent to the user's client: a text message response by the agent (e.g., the direction and telephone number of the requested shop); the user can process the received message at any time he pleases.

Response form d—image message sent to the user's client: an image message (e.g., a drawing with the instructions of how to connect the washing machine at home); the user can process the received message at any time he pleases.

Response form e—video message sent to the user's client: a video message (e.g., a video presenting the unique features of the product that the user requested information about); the user can process the received message at any time he pleases.

Response form f—call to the user to be able to discuss the issue directly with the user: if the case raised by the user requires a dialogue between the user and the operator (e.g., a complaint regarding the last energy invoice), the call centre agent can decide to call the user back. In this case, the user is able to send a request to the call centre and doesn't have to wait on the phone until it is answered by the agent nor does he need to hold the line till the operator has found out the necessary details for them to be able to process the case.

Response form h: one-off chat triggered from the call centre.

Response form i: or any combinations of the above cases.

FIG. 13 shows a user A with an instant messaging client in his Device, a messaging server, a call center that receives customer inquiries and an Operator who process the inquiries. When user A wants to place a request to the call center, he composes a multimedia message (text/audio/image/video) with his Device and addresses it to the Call center virtual buddy. The Device sends the message to the Server FIG. 13 (a), and the Server forwards it to the call center FIG. 13 (b) over a specified API. The operator retrieves the message at the time when he can process it FIG. 13 (c) and sends a response to user A via the messaging protocol in the form, for example, of a multimedia message with text/audio/image/video FIG. 13 (d) or triggers a call back to user A to address the issue over a call session FIG. 13 (e) or a combination of both of them.

Users can have a “call centre” virtual buddy; this way, any message sent to that virtual buddy will be automatically directed to the call centre behind that application. A virtual buddy can be added by the action of the end user (e.g., a user who wants to use this messaging methodology in his dealings with an airline company will add the unique alias of the virtual buddy) or it can be activated in the user's buddy list by the system administrator without requiring a direct action of the end user (e.g., a company sponsoring a number of users can push one or more virtual buddies to the sponsored users).

A virtual buddy can be set to be always on-line (meaning that the service is always available—e.g., a 24/7 service desk) or they can be set to off-line whenever required (for example to indicate that the call centre is closed at this time and the request will not be processed until it opens again). The position of a virtual buddy in the buddy list is as well configurable by the system (always on top, always at the bottom, always on top of the offline buddies, etc.).

A virtual buddy can also produce an auto response (e.g., “thank you for your inquiry, we will get back as soon as possible”, or “we are closed at present, we will process your inquiry during business hours”). The auto response can be of the form text/image/audio/video or a combination of them.

As can be seen from the above-noted discussion with respect to the voice message that is delivered as a call to the receiver, the present invention provides at least the following novel concepts:
(1) A user can record a voice message from, say, a PC and send it to a contact, with the contact receiving the audio message delivered as a call.
(2) The sender of the voice message, prior to submitting the message, can select the options that he offers the remote receiver (call back Y/N, who pays for the call back, reply path Y/N, DTMF response mechanism, forward audio message Y/N, etc. . . . ).
(3) Audio chatting sessions (back and forth) are enabled between a traditional instant messaging interface and a wired fixed phone, cordless phone, VoIP phone or mobile phone.
(4) The software client can notify in real time the “presence” of the receiver of the call. For example, if user B does not hang up after replying to the message, user A will hence be notified that user B remains available (“online” in that particular call session—in a call session with the IVR system) and can resume the messaging loop all over again (but in this case knowing that user B remains on the telephone awaiting for additional messages).
(5) The sender of the audio message can see in his messaging client and in real time whether the receiver has picked up the phone call and listened to the audio message.

As can be seen from the above-noted discussion with respect to multimedia messaging between a messaging client and SMS/MMS, Email, IM from other communities, the present invention provides at least the following novel concepts:
(1) The server stores the multimedia content and generates a unique URL/hyperlink linking to that content.
(2) The browser environment provides the means for user B to reply with text, audio, image or video captured within the web/wap session or by simply uploading a file with the intended multimedia content.
(3) The receiver (Email user, SMS/MMS user, IM user from another community) of the multimedia message can order a call back with a single click in the browser environment. After that, both sender and receiver will receive a call in their registered telephone numbers and both calls will be automatically bridged together.
(4) The sender can see in his client whether and when the receiver has retrieved the audio message since the unique URL associated to user A's message is tagged, and when user B retrieves the content, user A can be notified in real time by the system. The essential significance of this point is that, for example, the sender does not only know that the email-SMS-MMS-IM message has been delivered; he can also know when the audio message has been retrieved and listened to.
(5) SMS/MMS-email users can join an instant multimedia messaging facility without need to install any specific software on their electronic equipment.

As can be seen from the above-noted discussion with respect to intelligent message delivery, the present invention allows, for example, specific user segments that may not have the capability to understand and control the multiple communication channels that can be used at any time to reach their correspondents can use the traditional instant messaging interface to communicate with their contacts

As can be seen from the above-noted discussion with respect to the message board & blogcast features, the present invention disclosed herein provides at least the following advantages:
(1) Users can post messages into a message board and/or blogcast via a virtual buddy within their buddy list.
(2) Users can retrieve/view messages from a message board and/or blogcast via a virtual buddy within their buddy list.
(3) Users can be notified of new messages in a message board and/or blogcast via a virtual buddy within their buddy list.
(4) The virtual buddy's presence can be set according to the message board's and/or blogcast's status, availability, readiness, etc.

As can be seen from the above-noted discussion with respect to the one-off chat space feature, the present invention provides, for example, the establishment of a traditional chatting session from your instant messaging interface, with any person that you know the mobile number of, without need to have a prior buddy-acceptance process, and leaving no residual information or future presence-sharing between the participants after the session.

As can be seen from the above-noted discussion with respect to the queue-free call centre feature, the present invention provides at least the following advantage:
(1) Users can submit multimedia messages from their messaging client when dealing with a call centre so that they don't need to wait for their call to be picked up and for their question to be researched and responded.
(2) The response from the call centre back to the user can be in several forms.

(3) Users can have a “call centre” virtual buddy.
(4) The virtual buddy's presence can be set to indicate the level of response availability by the call center.

When the present invention is practiced with a mobile device, a software client either is programmed into the mobile device when it is manufactured or is downloaded into the mobile device by means of an appropriate internet connection or wireless network. The client allows a user to create entries (e.g., take a picture+record an audio/record a video) and then send it. This opens the opportunity to add advertising in the mobile client.

When the present invention is practiced by means of a website (e.g., www.amicast.com or m.amivox.com), the website host can generate advertising revenue in connection with the website. For example, when you play an entry (see below), ads appear at the bottom of the picture in question for which revenue can be generated on a “per-click” or on a “per view” basis. It is possible to put a column of ads on the right side of the graphic user interface so that ads can be played when entries are not being played.

In accordance with an exemplary embodiment of the present invention, a user sets up a “buddy list” that identifies people and the various ways with which communication with that person can take place (such as an email address, a cell phone number, and a land line phone number). This can be directly in a mobile device by means of a software client or in a server when a web-based embodiment is uses.

Once the buddy list is made, a user sets up default settings for how to communicate with his or her buddies. Next, the user records a voice message or other entry. Next, the user selects the buddies to whom the message is sent, and then clicks “send.” The software causes the message to be sent to the buddies. If the buddy can communicate via the same way of the default setting, then the voice message is transposed into that format and delivered. If the buddy can't communicate in that way, the software figures out a way that will work and the causes the message to be sent to the recipient.

On the receiving end, a recipient can listen to the message, and then respond to it by sending a response voice message. When the message is sent back to the sender, it goes to the graphic user interface on the sender's device (PC, laptop or phone) that shows the Amivox website or client.

The invention's messaging client indeed allows users to edit their contacts list by introducing their contacts' mobile number(s), fixed number(s), email address(es) and IM address(es) (e.g., Hotmail, MSN, Yahoo accounts). For a user to sign up in this invention's service, he needs to provide his mobile number and email address. The following are specific examples of how the invention can be used.

### Example 1

John opens his PC's browser and logs in the invention's web page. Now he sees his contacts list. He records a VM to Anne and sends it as a micro call. (Notice that John selects how to send it, it isn't the system that it's preprogrammed to take that decision). Anne receives a call; she can tell that John is calling since she sees his number as the calling line identification. As soon as she answers, a system voice greets with a short announcement “THIS IS A SHOUT MESSAGE!” and right away she listens to John's VM. After the VM, the system voice provides options such as “TO LISTEN AGAIN PRESS 1—TO REPLY WITH A VOICE MESSAGE PRESS 2—TO ESTABLISH A CALL BACK WITH JOHN PRESS 3 ( . . . )”. If she presses “2”, the system voice says “RECORD A MESSAGE AFTER THE TONE AND PRESS # OR HANG UP” and Anne records a message and hangs up. Almost instantly, John's browser shows that Anne has replied with a VM and he can listen to it by simply clicking on “Play”. When Anne answered the call, John could see right away on his browser's UI that she had answered the call and that she is “online” (meaning that she still is on the call). When she hangs up, John can tell that she no longer is “online”. [If Anne hadn't answered the call, John would have received a notification and he could have decided to redirect it as email/SMS/MSM/IM] In case Anne decides to stay online after recording her VM, John can tell that she remains online and record additional VMs and send them to Anne (who will receive them on real time since no call session shall be triggered), and Anne can as well respond to them one by one. So, we have created the means for a user on a browser and a telephone user to chat via voice messages.

### Example 2

John records a short video from his Webcam and sends it as an EMAIL/SMS/MMS/IM. Anne will press on a unique link included in the EMAIL/SMS/MMS/IM, a browser session will open from where she will play the received message. From the very same browser she can create a multimedia message and send it back to John. Both John and Anne can see on their respective browser sessions whether the other party is still online, hence knowing in advance whether the receiver will get the message right away. Anne can as well press on the “Call back” button FIG. 5 (f) and a call back is triggered between both parties.

### Example 3

Same as above, but John is using a browser from his mobile phone, PDA, or any other electronic device that allows browsing into the internet.

### Example 4

Same as above, but John is using a client (software downloaded into the PC, mobile phone, PDA, or any other electronic device). In this case, John experiences the service within a client (as opposed to a browser).

In accordance with these examples, if by the time Anne responds with a message John has gone offline, he will receive a notification of the new message. John defines the means how he receives notifications (email, SMS, MMS, call, at what frequency, etc.). Next time John logs into the service he will be able to view/hear the message. Moreover, if by the time John responds with an additional message Anne has gone offline (she has hang up or has closed the browser session that she opened with the unique URL), the system is defined so that John is notified that the message won't be answered within the session previously established (call-unique browser URL) and he is if offered options such as “establish another micro call”-“send as email”-“send as sms/mms”-“send as IM” ( . . . )

FIG. 8-9 is an exemplary embodiment where the system is setup to decide the best delivery sequence for the receiver (Anne). In this case, whatever delivery means John chooses, the message will follow the logic set by Anne. In such case, John can be notified prior to sending so that he doesn't bother with selecting a delivery means.

FIG. 13 shows what we believe to be a pretty useful application for this kind of voice messaging sequences (queue-free call center).

A device incorporating one or more aspects of the claimed invention comprises a program memory; a data storage memory; a processor that is operatively coupled to the program memory and the data storage memory; wherein the program memory contains a first set of instructions that, when executed, causes a first graphic user interface to be displayed on a display screen with which a user can interact to set up a buddy list that identifies at least one contact and the various ways with which communication with the at least one contact can take place; wherein the program memory contains a second set of instructions that, when executed, causes a second graphic user interface to be displayed on the display screen with which a user can interact to set up default settings for how to communicate with the at least one contact identified in the buddy list; wherein the program memory contains a third set of instructions that, when executed, causes a third graphic user interface to be displayed on the display screen with which a user can interact to record an entry or to fetch an entry comprising existing multimedia content previously stored in the device or on an external memory; wherein the program memory contains a fourth set of instructions that, when executed causes a fourth graphic user interface to be displayed on the display screen with which a user can interact to select at least one contact in the buddy list to whom the entry is to be sent and then send the selected entry to the selected contacts; and wherein the program memory contains a fourth set of instructions that, when executed, determines if each selected contact is capable of receiving messages in accordance with the default settings and, for each selected contact that is capable of receiving the entry in the default format, sending the entry to that selected contact and, for each selected contact that is not capable of receiving the entry in the format of the default settings, then transposing the message into a format capable of being received by the incapable selected buddies and then sending the entry to them.

The claimed device is further distinguished by the fact that the ways with which a user can communicate with the at least one contact on the buddy list comprise as an email address, a cell phone number, a land line phone number or an instant message address. The claimed device is further distinguished by the data storage memory, the program memory and the processor form, for example, a mobile device, a smartphone, a computer or a server that is connectable to the internet. The claimed device is further distinguished by the fact that entry comprises a voice message. The claimed device is further distinguished by the fact that the first, second, third and fourth sets of instructions are downloaded into the program memory by means of an end user's interaction with a website. The claimed device is further distinguished by the fact that the first, second, third and fourth sets of instructions are loaded into the program memory when the device is manufactured. The claimed device is further distinguished by the fact that the display screen may form a part of the device.

It should be understood that it is within the scope of the claimed invention to have an electronic device having a program memory, a data storage memory, and at least one processor, wherein the electronic device is programmed to allow a graphic user interface to be shown on a display screen to a user so that one or more of the novel functions described herein can be implemented. One such device would be, for example, a server that is adapted to receive appropriate communication signals from a computing device (e.g., personal computer, laptop computer or a smart phone like Apple's iPhone or Blackberry Bold.

It should also be understood that it is within the scope of the claimed invention to cover a method of performing one or more of the novel steps disclosed herein. For example, communications between the electronic device and server shown in FIG. 1 can take place by means of a network access point (e.g., a cell phone tower, a wireless internet access point or a cable or dsl modem) and an internet connection. One of the novel methods disclosed herein concerns the transmission of the signals over a communications network that allows the invention disclosed herein to be performed. As one example, it is applicants' intention to cover a method where the transmission of signals takes place through a particular country, with the origin of those signals taking place in other countries.

While the present invention has been described with reference to specific examples, which are intended to be illustrative only and not to be limiting of the invention, it will be apparent to those of ordinary skill in the art that changes, additions or deletions in addition to those explicitly described above may be made to the disclosed embodiments without departing from the spirit and scope of the invention.

What is claimed is:

1. A device, comprising:
a program memory;
a data storage memory;
a processor that is operatively coupled to the program memory and the data storage memory;
wherein the program memory contains a first set of instructions that, when executed, causes a first graphic user interface to be displayed on a display screen with which a user can interact to set up a buddy list that identifies at least one contact and the various ways with which communication with the at least one contact can take place;
wherein the program memory contains a second set of instructions that, when executed, causes a second graphic user interface to be displayed on the display screen with which a user can interact to set up default settings for how to communicate with the at least one contact identified in the buddy list;
wherein the program memory contains a third set of instructions that, when executed, causes a third graphic user interface to be displayed on the display screen with which a user can interact to record an entry or to fetch an entry comprising existing multimedia content previously stored in the device or on an external memory;
wherein the program memory contains a fourth set of instructions that, when executed causes a fourth graphic user interface to be displayed on the display screen with which a user can interact to select at least one contact in the buddy list to whom the entry is to be sent and then send the selected entry to the selected contacts; and
wherein the program memory contains a fourth set of instructions that, when executed, determines if each selected contact is capable of receiving messages in accordance with the default settings and, for each selected contact that is capable of receiving the entry in the default format, sending the entry to that selected contact and, for each selected contact that is not capable of receiving the entry in the format of the default settings, then transposing the message into a format capable of being received by the incapable selected buddies and then sending the entry to them.

2. The device of claim 1, wherein the ways with which a user can communicate with the at least one contact on the buddy list comprise as an email address, a cell phone number, a land line phone number and an instant message address.

3. The device of claim 1, wherein the data storage memory, the program memory and the processor form a mobile device.

4. The device of claim 3, wherein the mobile device forms a smartphone.

5. The device of claim 1, wherein the data storage memory, the program memory and the processor form a computer that is connectable to the internet.

6. The device of claim 5, wherein the computer comprises a server.

7. The device of claim 1, wherein the entry comprises an audio voice message.

8. The device of claim 1, wherein the first, second, third and fourth sets of instructions are downloaded into the program memory by means of an end user's interaction with a website.

9. The device of claim 1, wherein the first, second, third and fourth sets of instructions are loaded into the program memory before the device is sold to an initial end user.

10. The device of claim 1, wherein the display screen forms a part of the device.
